(19) United States
(12) Patent Application Publication
(10) Pub. No.: US 2023/0014338 A1
(43) Pub. Date: Jan. 19, 2023

(54) ELECTRICAL STORAGE BATTERY AND VEHICLE

(71) Applicant: FAURECIA SYSTEMES D'ECHAPPEMENT, VANTERRE (FR)

(72) Inventors: Frédéric GREBER, ECOT (FR); Philippe ACHON, PFAFFENHEIM (FR)

(21) Appl. No.: 17/622,597

(22) PCT Filed: Jun. 25, 2020
(86) PCT No.: PCT/EP2020/067878

§ 371 Date: Oct. 3, 2022

(30) Foreign Application Priority Data
Jun. 28, 2019 (FR) FR1907192

(51) Int. Cl. H01M 10/6556; H01M 10/613; H01M 10/625; H01M 10/6551; H01M 50/249; H01M 50/242; H01M 10/6567; B60L 50/64; B60L 58/26

(52) U.S. Cl. CPC H01M 10/6556; H01M 10/613; H01M 10/625; H01M 10/6551; H01M 50/249; H01M 50/242; H01M 10/6567; B60L 50/64; B60L 58/26; H01M 2220/20

(57) ABSTRACT

The battery (1) comprises:
an enclosure (5) internally delimiting a volume (7) for receiving the electricity storage cells (3);
a heat exchanger (11) comprising an upper metal plate (13) defining the bottom of the enclosure (5), a bottom plate (15) delimiting with the upper plate (13) a circulation volume (17) for a heat transfer fluid, and a plurality of upper fins (19) housed in the circulation volume (17) and arranged to transmit forces between the upper and bottom plates (13, 15);
a protective plate (23) covering the bottom plate (15) and defining with the bottom plate (15) a lower volume (25);
lower stiffening fins (27) housed in the lower volume (25) and arranged to transmit forces between the protective plate (23) and the bottom plate (15), the bottom plate (15) forming with the lower fins (27) and the protection plate (23) a rigid frame (28) absorbing most of the forces to which the battery (1) is subjected.

The invention relates in general to electrical storage batteries, particularly for motor vehicles.

In vehicles powered by an electric motor, or in hybrid vehicles, such batteries contain a large number of electricity storage cells. The batteries are therefore heavy and cumbersome.

It is possible to fit such batteries under the vehicle.

In this case, the bottom of the battery must comply with a large number of constraints. It must be able to cool the electricity storage cells, support the weight of the cells, and protect the cells from possible intrusion from below, for example by an object being thrown from the roadway or by an impact with an obstacle on the roadway.

These constraints are particularly difficult to meet because of the very heavy weight of the electricity storage cells.

In this context, the invention aims to provide a battery that meets the above constraints.

To this end, the invention relates in a first aspect to an electricity storage battery for a vehicle comprising:
a plurality of electricity storage cells;
   an enclosure internally defining a volume for receiving the electricity storage cells;
   a heat exchanger comprising a metallic top plate defining the bottom of the enclosure, a bottom plate defining with the top plate a flow volume for a heat transfer fluid, and a plurality of upper fins located in the flow volume, the upper fins extending in a first direction, the upper fins being arranged to transmit forces between the top and bottom plates;
   a protective plate covering the bottom plate and defining with the bottom plate a lower volume;
   lower stiffening fins housed in the lower volume, the lower fins extending in a second direction and being arranged to transmit forces between the protective plate and the bottom plate, the bottom plate forming with the lower fins and the protective plate a rigid frame taking up most of the forces to which the battery is subjected.

The structure of the battery allows the requirements described above to be met.

The cooling of the electricity storage cells is achieved by circulating the heat transfer fluid in the volume between the top and bottom plates. The metal top plate, which forms the bottom of the enclosure, allows efficient heat transfer between the cells and the heat transfer fluid.

The presence of the upper and lower fins gives a high degree of rigidity to the sandwich structure forming the bottom of the battery, namely the top plate, bottom plate, protective plate, upper fins and lower fins. This sandwich structure can support the very heavy weight of the electricity storage cells.

Furthermore, in the event of an impact on the battery from below, some of the impact energy is absorbed by deformation of the protective plate and/or the lower fins and/or the upper fins. The deformation of the bottom plate also helps to absorb some of the impact energy.

In addition, the lower fins help to increase the impact area, and thus reduce the residual force per unit area. This is also true of the upper fins.

Thus, the sandwich of three plates and two sets of fins prevents any external element from damaging the electricity storage cells, which could lead to a battery fire.

The upper and lower fins contribute to the resistance of the electricity storage battery to lateral forces in the first or second direction.

Advantageously, it is easy to adapt the behaviour of the support structure of the sandwich electricity storage cells to any case:

mass of the electricity storage cells;

energy of the impact against the protective plate;

lateral rigidity required in the event of a side impact.

The adjustable parameters are:

the height of the lower fins;

the height of the upper fins;

fin design;

the material in which the fins are made;

the material of the protective plate;

the connections provided between the plates, or between the upper and lower fins and the plates.

It is important to emphasize that the sandwich structure is very light and has very attractive performance because all the functions are linked and shared. In other words, all the elements of the sandwich structure contribute to intrusion protection, bending resistance, and side impact resistance.

The storage battery may furthermore exhibit one or more of the following features, taken in isolation or in any combination that is technically possible:

the enclosure comprises a lower tray and a lid, the lower tray comprising the top plate and an upright edge tending towards the lid;

the battery has an external mechanical reinforcement, interposed between the upright edge of the lower tray and a peripheral edge of the protective plate;

the upright edge comprises two first sections parallel to the first direction and two second sections parallel to the second direction and connecting the two first sections to each other, the external mechanical reinforcement comprising two third plates folded into slots parallel to the first direction and applied against the first sections, and two fourth plates folded into slots parallel to the second direction and applied against the second sections;

the protective plate comprises a central bottom, the peripheral edge comprising two first segments parallel to the first direction and made of a first material, and two second segments parallel to the second direction and made of a second material less rigid than the first material;

the first and second directions form an angle between 60° and 120°;

the battery comprises:

* an upper angle extending around the entire periphery of the enclosure, comprising a first upper flange pressed against the frame and integral with the frame, and a second upper flange extending opposite the upright edge;
* a lower angle extending around the periphery of the enclosure, comprising a first lower flange pressed against the frame and integral with the frame, and a second lower flange extending opposite the upright edge;

the first upper flange of the upper angle and the first lower flange of the lower angle are superimposed at a distance apart, one above the other, and each have a width greater than 30 mm;

the second upper flange of the upper angle and the second lower flange of the lower angle are pressed against each other and are rigidly attached to each other;

the lower fins form an angle of between 30° and 60° to a normal direction substantially perpendicular to the first and second directions;

the frame comprises an additional protective plate covering the protective plate, and defining with the protective plate an additional volume, and additional fins housed in the additional volume, the additional fins extending along a third direction and being arranged to transmit forces between the protective plate and the additional protective plate;

the third direction forms an angle between 60° and 120° with the second direction.

According to a second aspect, the invention relates to a vehicle equipped with an electricity storage battery having the above characteristics, the battery being placed under the vehicle such that the protective plate is located opposite the running surface.

According to a third aspect, the invention relates to a vehicle equipped with an electricity storage battery having the above characteristics, the vehicle having a normal longitudinal direction of travel, the third direction forming an angle of between 30° and 60° to the longitudinal direction.

Further features and advantages of the invention will be apparent from the detailed description given below, by way of indication and not in any way limiting, with reference to the appended figures, among which:

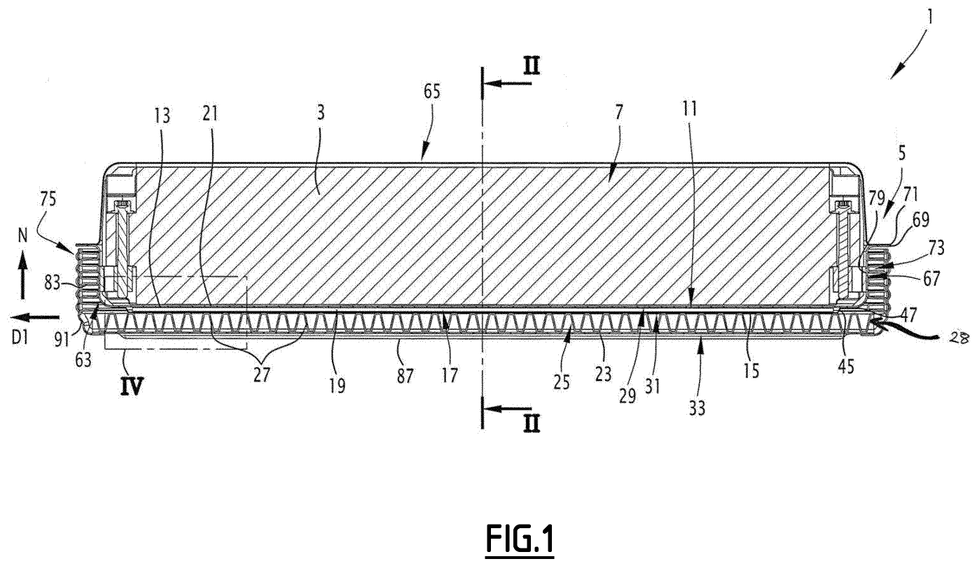

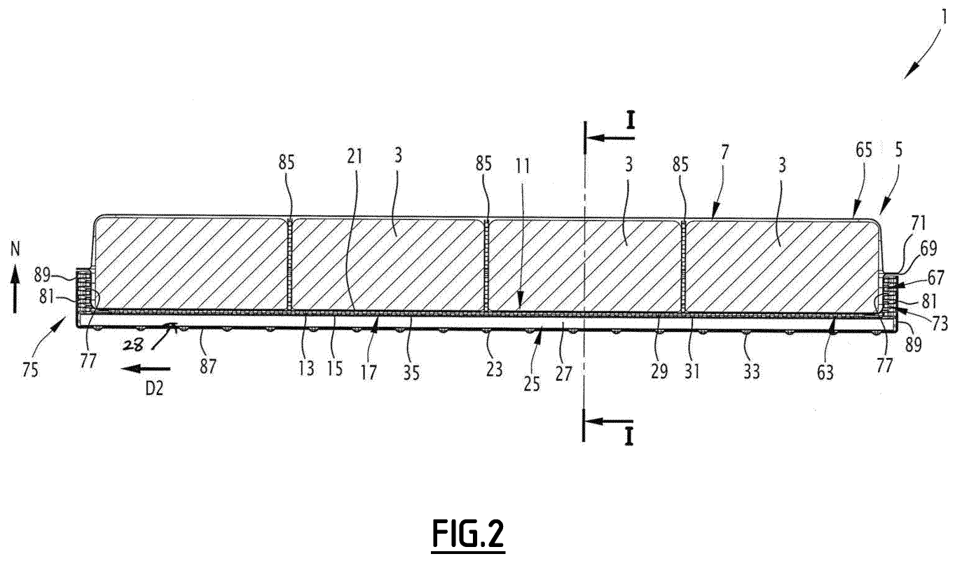

FIG. 1 is a cross-sectional view of the electricity storage battery according to a first embodiment of the invention, taken in a plane containing the first direction, considered along the incidence of the arrows I in FIG. 2;

FIG. 2 is a cross-sectional view of the electricity storage battery of FIG. 1, taken in a plane containing the second direction, considered along the incidence of the arrows II in FIG. 1;

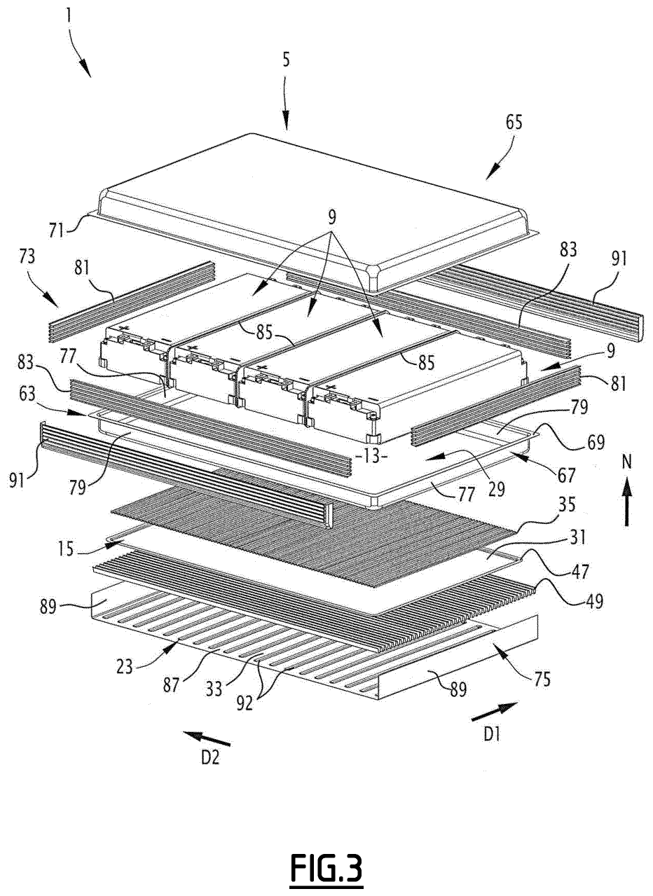

FIG. 3 is an exploded perspective view of the battery in FIGS. 1 and 2;

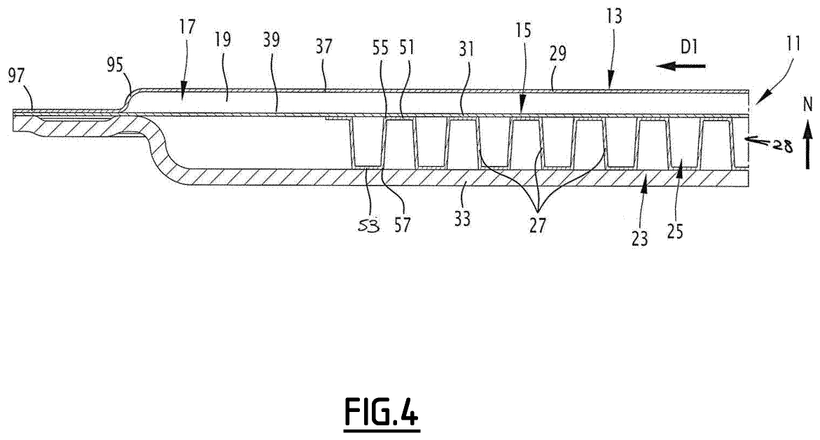

FIG. 4 is a cross-sectional view of the bottom of the battery, for a variant of the first embodiment of the invention;

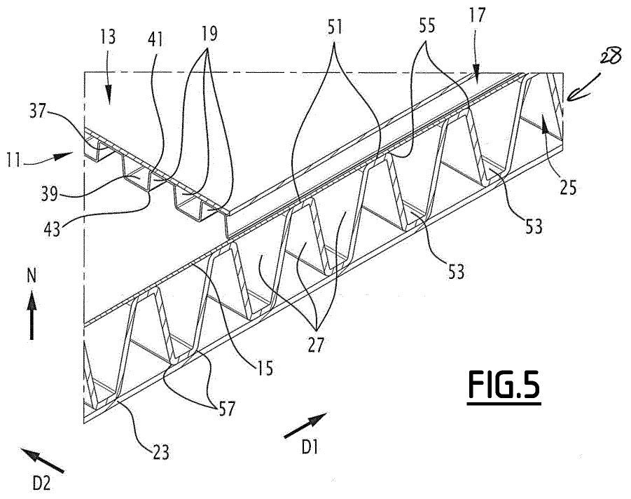

FIG. 5 is a perspective view showing the arrangement of the upper and lower fins of the battery in FIGS. 1 to 5;

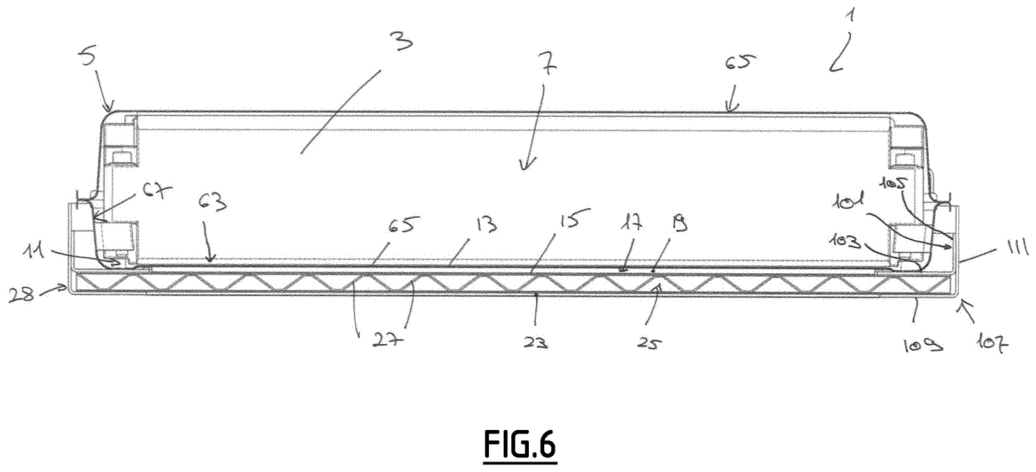

FIG. 6 is a cross-sectional view, similar to FIG. 1, for a second embodiment of the invention,

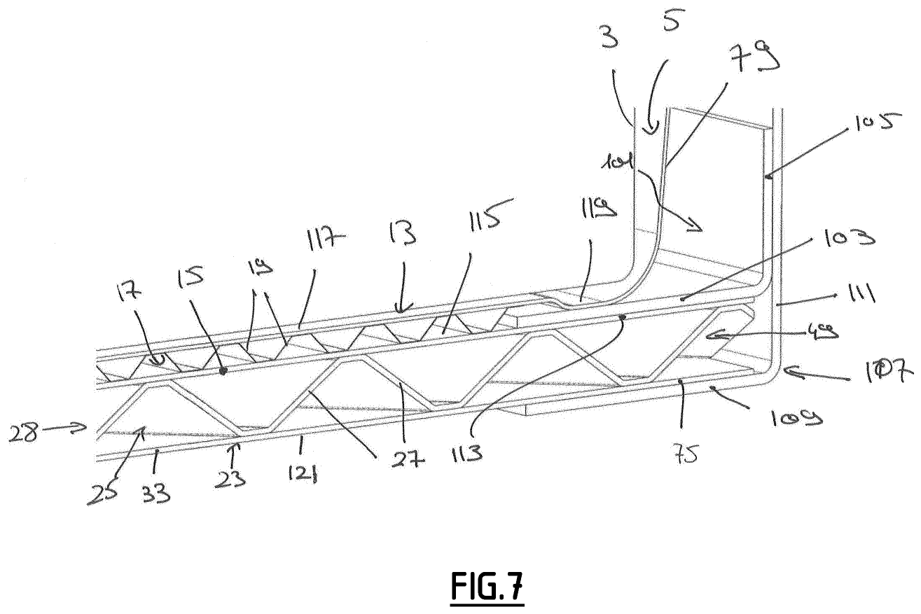

FIG. 7 is a detailed perspective view of the battery of FIG. 6;

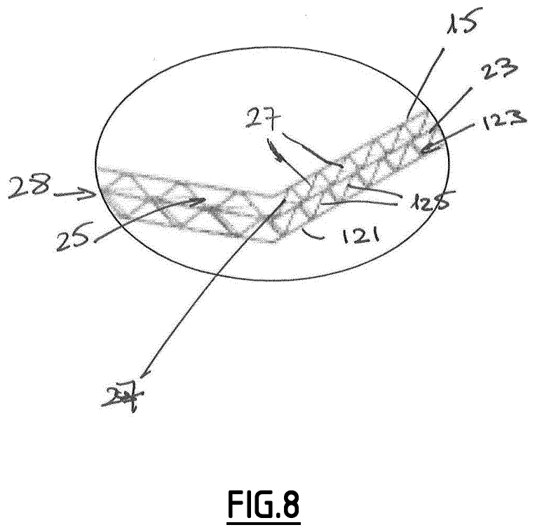

FIG. 8 is a perspective view of the frame, for a variant of the second embodiment, with a cutaway showing the internal structure;

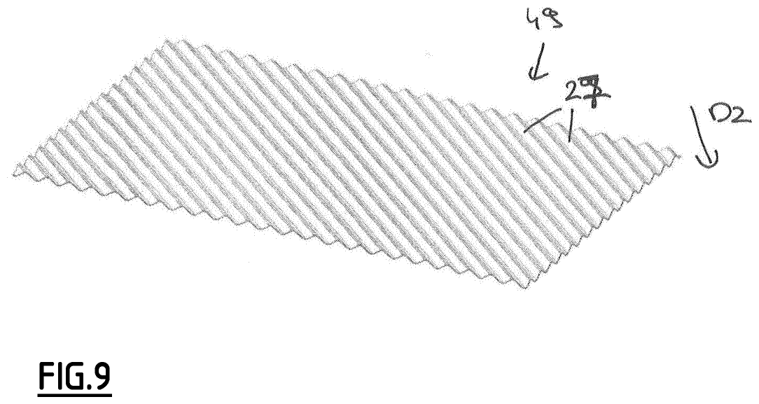

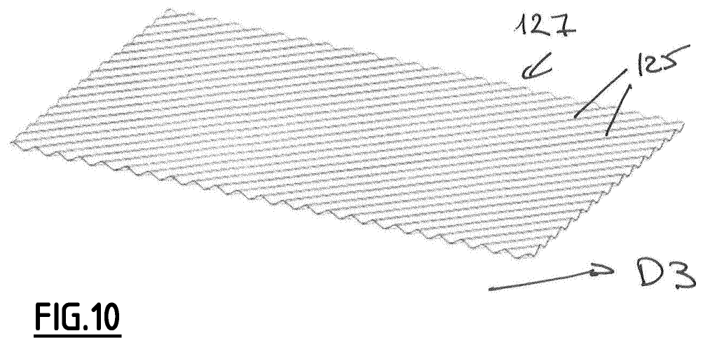

FIGS. 9 and 10 are perspective views of the lower fins and additional fins of FIG. 8; and

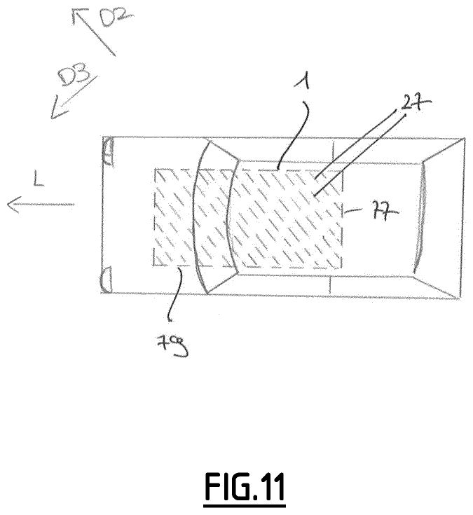

FIG. 11 is a schematic representation, in top view, of a vehicle equipped with the battery according to the variant of the second embodiment.

The electric battery 1 shown in FIGS. 1 to 3 is intended for use in a vehicle, typically a motor vehicle such as a car, bus or truck.

The vehicle is, for example, a vehicle powered by an electric motor, the motor being electrically powered by the electric battery. In one variant, the vehicle is of the hybrid type, and thus comprises an internal combustion engine and an electric motor powered electrically by the electric battery. In yet another variant, the vehicle is powered by an internal combustion engine, with the electric battery being provided to power other vehicle equipment, for example the starter, lights, etc.

The electric battery shown in FIGS. 1 to 3 is according to a first embodiment of the invention.

The battery 1 comprises a plurality of electricity storage cells 3, and an enclosure 5 internally defining a volume 7 for receiving the electricity storage cells 3.

The battery 1 typically comprises a large number of electricity storage cells 3, typically several dozen electricity storage cells 3.

Electricity storage cells 3 are of any suitable type: Lithium cells of the lithium-ion polymer (Li-Po), lithium iron phosphate (LFP), lithium cobalt (LCO), lithium manganese (LMO), nickel manganese cobalt (NMC) types, and typical cells (NiMH or nickel-metal hydride).

The storage cells 3 are distributed in one or more modules 9, typically in a plurality of modules 9. In the example shown in the figures, the electric battery 1 comprises four modules 9. Alternatively, the battery has a different number of modules 9, such as eight, twelve or any other number.

The number of modules 9 depends on the desired capacity for the battery 1.

The electricity storage battery 1 further comprises a heat exchanger 11. The heat exchanger 11 comprises a metal top plate 13 defining the bottom of the enclosure 5, a bottom plate 15 delimiting with the top plate 13 a circulation volume 17 for a heat transfer fluid, and a plurality of upper fins 19, housed in the circulation volume 17.

The upper fins 19 extend in a first direction D1 and are arranged to transmit forces between the top and bottom plates 13, 15.

The electricity storage cells 3 rest on the top plate 13.

Specifically, the modules 9 are in contact with the top plate 13, either directly or via a layer of thermal paste 21, providing thermal contact between the modules 9 and the top plate 13.

Typically, the top plate 13 is made of aluminium, or an aluminium alloy. This ensures efficient heat exchange between the cells 3 and the heat transfer fluid.

Alternatively, the top plate 13 is made of steel, high-strength steel or stainless steel.

The battery 1 further comprises a protective plate 23 covering the bottom plate 15 and defining a lower volume 25 with the bottom plate 15.

The battery 1 further comprises lower stiffening fins 27, housed in the lower volume 25.

The lower fins 27 extend in a second direction D2. They are arranged to transmit forces between the protective plate 23 and the bottom plate 15.

The bottom plate 15, together with the lower fins 27 and the protective plate 23, forms a rigid frame 28 which absorbs the majority of the forces to which the battery is subjected. The frame 28 absorbs at least 80% of the forces, preferably at least 90% of the forces, more preferably at least 95% of the forces.

The second direction D2 is advantageously not parallel to the first direction D1. Typically, the first and second directions D1, D2 form an angle between 60° and 120°, preferably between 80° and 100°, and preferably 90°.

In other words, the lower fins 27 and the upper fins 19 are preferably perpendicular to each other.

The top plate 13, the bottom plate 15 and the protective plate 23 have respective main areas 29, 31, 33 facing each other, substantially parallel to each other. They are perpendicular to the same normal direction N, shown in the figures. The first and second directions D1, D2 are typically substantially perpendicular to the normal direction N.

The main areas 29, 31, 33 cover substantially at least 80% of the corresponding plates 13, 15, 23.

The main areas 29 and 31 are essentially flat. They are spaced from each other in the normal direction N by a height corresponding to the height of the upper fins 19. Typically, this height is between 2 and 10 mm, preferably between 3 and 5 mm, and is for example 4 mm.

The heat transfer fluid circulating in the circulation volume 17 is of any suitable type. For example, this fluid is glycol water.

The heat exchanger 11 has a heat transfer fluid inlet and heat transfer fluid outlet, not shown, which open into the circulation volume 17. The heat transfer fluid inlet and the heat transfer fluid outlet are designed to be connected to a heat transfer fluid circuit typically comprising a circulation device such as a pump, and a device for discharging the heat taken from the electricity storage cells 3 by the heat transfer fluid.

The upper fins 19 are arranged to define circulation channels for the heat transfer fluid from the inlet to the outlet.

The upper fins 19 are formed by a first metal plate 35 bent into slots.

Thus, the upper fins 19 are connected to each other by first upper flats 37 bearing against the upper plate 13, and by first lower flats 39 bearing against the bottom plate 15. The upper fins 19 are juxtaposed, and are substantially parallel to each other. Each upper fin 19 extends in a plane containing the first direction D1 and containing the normal direction N, or containing the first direction D1 and slightly inclined to the normal direction N. Slightly inclined means an angle of less than 20°. The upper fins 19 are evenly spaced from each other along the second direction D2. Each fin 19 is thus framed by two neighbouring fins.

Each upper fin 19 has an upper edge 41 and a lower edge 43, extending in the first direction D1 (FIG. 5).

The upper edge 41 of each fin 19 is connected by one of the upper flats 37 to one of the two adjacent fins. The lower edge 43 is connected by a lower flat 39 to the other adjacent fin.

The first upper flats 37 are rigidly attached to the top plate 13. Typically, they are attached by soldering or gluing. By soldering or gluing, substantially the entire surface of the first upper flat 37 is rigidly connected to the top plate 13.

Similarly, the first lower flats 39 are rigidly attached to the bottom plate 15. They are typically brazed or glued, each over substantially its entire surface.

Furthermore, the first upper flats 37, in normal projection on the top plate 13, cover at least 30% of the surface of the normal projection of the first metal plate 35 on the top plate 13. Preferably, the normal projections of the first upper flats 37 together cover between 41 and 48% of the normal projection of the first metal plate 35.

In other words, the fins 19 are practically parallel to the normal direction N, so that the first upper flats 37 cover a proportion close to 50% of the normal projection of the first metal plate 35. Thus, the surface area of the first metal plate 35 rigidly attached to the top plate 13 is very high, so that there is no need for expensive fastening means. It is not necessary to achieve an extremely high gluing or soldering force between the first upper flats 37 and the top plate 13. The bonding or soldering force per unit area is a function of the mechanical strength of the upper fins 19.

Furthermore, the first lower flats 39, in normal projection on the bottom plate 15, cover at least 30% of the surface of the normal projection of the first metal plate 35 on the bottom plate 15. The normal projections of the first lower flats 39 together typically cover between 41 and 48% of the normal projection of the first metal plate 35.

Again, this large area of attachment of the first metal plate 35 to the bottom plate 15 means that there is no need for an expensive fastening means between the first metal plate 35 and the bottom plate 15.

Typically, the first metal plate 35 is made of aluminium, or an aluminium alloy. Alternatively, the first metal plate 35 is made of steel, or of a high or very high yield strength steel, or of a dual phase steel (steel with two interlocking phases with grains in martensitic and ferritic form)

For example, the upper fins 19 have a height of between 3 and 5 mm, typically 4 mm, with a pitch, i.e. a spacing along the second direction D2, of between 3 and 5 mm, and typically 3 mm. The plate typically has a wall thickness of about 0.2 mm.

Thus, the top and bottom walls are connected to each other by a large number of vertical walls, spaced 3 to 5 mm apart. This gives the heat exchanger excellent rigidity.

In the embodiment shown in FIGS. 1 to 3, the bottom plate 15 has an edge 45 around the main area 31 which projects towards the top plate 13 and is extended by a projecting flange 47. The projecting flange 47 is pressed against the top plate 13. It is fixed in a heat transfer fluid-tight manner under the top plate 13.

In other words, the bottom plate 15 is slightly concave towards the top plate 13.

The bottom plate 15 is typically made of aluminium or an aluminium alloy. Alternatively, the bottom plate 15 is made of steel, high-strength steel or stainless steel.

Advantageously, the lower fins 27 are formed by a second metal plate 49 bent into slots.

The lower fins 27 are connected to each other by second upper flats 51 bearing against the bottom plate 15, and by second lower flats 53 bearing against the protective plate 23.

The lower fins 27 are substantially parallel to each other. They each extend in a plane containing the second direction D2 and the normal direction N, or in a plane containing the second direction D2 and slightly inclined to the normal direction N. Slightly inclined here means an angle of less than 20°.

The lower fins 27 are evenly spaced from each other along the first direction D1.

Each lower fin 27 has an upper edge 55 extending in the second direction D2 and a lower edge 57 extending in the second direction D2. Each lower fin 27 is framed by two other adjacent lower fins 27, arranged on either side along the first direction D1. The upper edge 55 of the lower fin 27 is connected to one of the two neighbouring fins by one of the upper flats 51. The lower edge 57 is connected to the other adjacent fin by one of the lower flats 53.

The second upper flats 51 are rigidly attached to the bottom plate 15. Each one is rigidly attached to the bottom plate 15 over substantially its entire surface. They are typically each attached by soldering or gluing.

Similarly, the second lower flats 53 are rigidly attached to the protective plate 23. Each one is attached to the protective plate 23 over almost its entire surface. They are each attached by soldering or gluing.

Thus, the area attached to the bottom plate 15 or the protective plate 23 is very large, so that no expensive fastening means are required.

The second upper flats 51, in normal projection on the bottom plate 15, cover at least 30% of the surface of the normal projection of the second metal plate 49 on said bottom plate 15. Preferably, the normal projections of the second upper flats 51 together cover 41-48% of the area of the normal projection of the second metal plate 49.

Furthermore, the second lower flats 53, in normal projection on the protective plate 23, cover at least 30% of the surface of the normal projection of the second metal plate 49 on the protective plate 23. The normal projections of the second lower flats 53 together preferably cover between 41 and 48% of the area of the normal projection of the second metal plate 49.

The height of the lower fins 27, taken in the normal direction, is between 4 and 14 mm, preferably between 5 and 10 mm, and is for example 7 mm. The pitch is typically between 3 and 8 mm, for example 4.5 mm.

Thus, due to their size, the lower fins 27 are relatively more rigid than the upper fins 19.

The second metal plate 49 has a thickness of between 0.5 and 2.5 mm, preferably between 0.7 and 1.5 mm, even more preferably about 1 mm, and advantageously equal to 1 mm.

It is made of steel, or high- or very high-yield-strength steel, or dual-phase steel, or aluminium or aluminium alloy.

The protective plate 23 is typically made of a Resin Transfer Molding (RTM) composite material, or steel, or high- or very high-yield-strength steel, or aluminium, or an aluminium alloy.

The RTM composite material preferably comprises a thermoplastic or thermoset material and a reinforcement. By way of example, this reinforcement may comprise fibres, a majority of the fibres being continuous fibres of length greater than 100 mm. Preferably, at least 50% by weight of the fibres are continuous fibres. These fibres are advantageously arranged in several layers, with orientations chosen to obtain excellent mechanical resistance according to the stresses. The thermoset material is for example a polyester, vinylester, epoxy, acrylic or a biobased resin. The thermoplastic material is, for example, a synthetic or biobased thermoplastic resin.

The reinforcement is, for example, glass, basalt, carbon, aramid, or HMPP (high molecular weight polypropylene). Alternatively, the reinforcement is made of flax, hemp, or another biobased fibre.

The protective plate 23 has a thickness of between 2 and 5 mm, preferably between 2.5 and 3.5 mm, even more preferably about 3 mm, and ideally equal to 3 mm.

Alternatively, the composite material is of the SMC (Sheet Molding Compound) type. It preferably comprises a thermoplastic or thermoset material and a reinforcement. By way of example, these reinforcements are fibres, with a majority of the fibres being short fibres of less than 51 mm (two inches) in length. These short fibres are typically chopped fibres.

Long fibres are advantageously arranged at certain points to locally reinforce the structure if necessary. These long fibres are longer than 100 mm. These long fibres are also known as continuous fibres.

In another embodiment, the protective plate 23 is made of aluminium foam or a sandwich of aluminium plate, aluminium foam and aluminium plate, these three thicknesses being atomically bonded by fusion.

In yet another embodiment, the protective plate 23 is made of a steel, in particular a high-yield-strength steel.

The function of the upper fins 19 is mainly to mechanically connect the upper plate 13 to the bottom plate 15. In particular, they allow forces to be transmitted in the normal direction N between the two plates. In addition, the upper fins 19 allow heat to be transferred from the top plate 13 to the heat transfer fluid.

The first metal plate 35, considered in normal projection on the top plate 13, covers the largest possible surface, and preferably covers at least 80% of the surface of the top plate 13.

The second metal plate 49, considered in normal projection on the bottom plate 15, covers the largest possible surface, and preferably covers at least 80% of the surface of the bottom plate 15.

According to another aspect of the invention, the enclosure 5 comprises a lower tray 63 and a lid 65. The lower tray 63 comprises, in addition to the top plate 13, an upright edge 67 tending towards the lid 65, with a closed contour, completely surrounding the top plate 13.

The lower tray 63 is advantageously integral, preferably deep-drawn. Thus, it is perfectly sealed, so that any liquid leakage from one of the electricity storage cells 3 would be contained by the lower tray 63. The lower tray 63 is of course made of the same material as the top plate 29. Thus, the bottom tray 63 is typically made of aluminium or an aluminium alloy, or alternatively of steel, high-yield-strength steel or stainless steel.

The depth of the bottom tray is about 45 mm. This depth depends on the ability of the chosen material to be deep-drawn. For materials that are not easy to deep-draw, the height is lower. However, if the material can be easily stretched, this value can be exceeded.

As can be seen in the figures, the upright edge 67 is extended outwards from the enclosure 5 by a projecting flange 69.

The lid 65 is concave towards the lower tray 63. The lid 65 has a free edge 71, forming a projecting flange which has exactly the same geometry and width as the flange 69 of the lower tray 63. The flanges 69 and 71 define a common parting line for the lid 65 and the lower tray 63.

The lid 65 and the lower tray 63 are rigidly attached to each other by any suitable means at this parting line.

The lid 65 has a depth corresponding to the height of the modules 9, reduced by the depth of the lower tray 63, plus a functional clearance.

The lid 65 is preferably made of aluminium or an aluminium alloy. Alternatively, it is made of steel for fire resistance reasons. Advantageously, it is made of stainless steel, resistant to both fire and corrosion. It is then preferably obtained by deep-drawing. In another variant, the lid 65 is made of a plastic or composite material. In this case, it is of the SMC (Sheet Molding Compound) type.

If the lid 65 is made of steel, it is preferably coated with a corrosion resistant coating, by zinc plating, cataphoresis, or any other method.

The battery 1 further comprises an external mechanical reinforcement 73, interposed between the upright edge 67 of the lower tray 63 and a peripheral edge 75 of the protective plate 23. The purpose of this external reinforcement 73 is to withstand the external lateral forces that the enclosure 5 undergoes during an accident or when a body strikes the lower part of the enclosure 5.

As seen in FIGS. 1 to 3, the upright edge 67 comprises two first sections 77 parallel to the first direction D1, and two second sections 79 parallel to the second direction D2 and connecting the two first sections 77 to each other.

The external mechanical reinforcement 73 comprises two third plates 81 bent into slots parallel to the first direction D1 and applied against the first sections 77. It also includes two fourth plates 83, bent into slots parallel to the second direction D2 and applied against the second sections 79. The third and fourth plates 81, 83 are bent like the first and second plates.

The third and fourth plates 81, 83 are rigidly fixed to the upright edge 67 by any suitable means: gluing, soldering, laser welding, spot welding, arc welding, clinching etc.

In any case, the third and fourth plates 81, 83 are attached to the upright edge 67 without creating a hole through the lower tray, for reasons of being leakproof.

The external mechanical reinforcement 73 allows, in the event of an external side impact, to distribute the forces over a large surface, leading to a decrease in the pressure per unit area exerted on the enclosure.

The external mechanical reinforcement 73 works by bending.

In addition, the battery 1 has at least one internal reinforcement plate 85, which is arranged inside the lower tray 63 and rigidly attached to the lower tray 63.

The or each internal reinforcement plate 85 is parallel to the first direction D1.

The or each internal reinforcement plate 85 is typically disposed between two electricity storage cell modules 9.

The or each internal reinforcement plate 85 extends from one of the two second sections 79 to the other second section 79. It is rigidly attached at both ends to the two second sections 79.

The or each internal reinforcement plate 85 typically extends in a plane containing the first direction D1 and the normal direction N.

The or each internal reinforcing plate 85 is made of aluminium or aluminium alloy, and is made of a folded sheet or extruded profile. Alternatively, the or each internal reinforcement plate 85 is a bent steel sheet, for example of high-yield strength, very-high-yield strength or dual-phase type steel.

Preferably, the or each internal reinforcement plate 85 is made of aluminium or an aluminium alloy if the lower tray 63 is itself made of aluminium or an aluminium alloy. The or each internal reinforcement plate 85 is made of steel if the lower tray is made of steel. This makes it possible to weld the internal reinforcement plate(s) 85 to the lower tray 63.

Alternatively, the or each internal reinforcement plate is glued or clinched to the lower tray 63, where a welded connection is difficult or impossible.

As shown in FIG. 3, the modules 9 are arranged in one or more rows extending in the second direction D2. An internal reinforcement plate 85 is placed between each pair of neighbouring modules 9.

The presence of internal reinforcement plate(s) makes the system mechanically very coherent and resistant to bending, torsion and compression (side impacts), as well as to intrusion.

Advantageously, the protective plate 23 comprises a central bottom 87, the peripheral edge 67 comprising two first segments 89 parallel to the first direction D1 and integral with the central bottom 87, and two second segments 91 parallel to the second direction D2. The second segments 91 have not been merged with the central base 87 and the first segments 89.

The central bottom 87 and the first two segments 89 are made of a first material, which has been described above. The second segments 91 are made of a second material which is less rigid than the first material.

The second segments 91 have no structural function, and are intended primarily to prevent the accumulation of dirt or liquid in the lower volume 25. The second segments 91 may be made of a less expensive material than the first material, for example a thin sheet metal.

The central background 87 corresponds substantially to the main area 33. It is reinforced by reliefs 92 made in the material constituting the central bottom 87.

As can be seen in FIG. 2, the third plates 81 are gripped between the first sections 77 and the first segments 89. The fourth plates 83 are gripped between the second sections 79 and the second segments 91 (FIG. 1).

In the event of an impact or lateral intrusion in the first direction, at the level of the second sections 79 of the upright edge 67, the rigidity of the battery is ensured mainly by the internal reinforcement plate(s) 85. These have a high degree of rigidity. The force first passes through the fourth plate 83, which allows the force to be distributed over a large area. The force is then transmitted to the upper fins 19 and the or each internal reinforcement plate 85. The protective plate 23 and the second segments 91 also contribute to the rigidity of the structure.

In the event of impact or lateral intrusion in the second direction D2, rigidity is mainly provided by the lower fins 27.

Indeed, due to their size, these fins are particularly rigid.

The force first passes through the third plate 81, which allows the force to be distributed over a large area. The force is then transmitted to the fourth plates 83 and the lower fins 27. The central bottom 87 and the first segments 89 of the protective plate 23 also contribute to the rigidity of the battery in this case.

A variant of the first embodiment of the invention will now be described with reference to FIG. 4.

Only the points in which this variant differs from that of FIGS. 1 to 3 will be detailed below. Elements that are identical or perform the same function in both variants will be designated by the same references.

In the embodiment shown in FIG. 4, the bottom plate 15 is not concave towards the top plate. On the contrary, it is quite flat.

The top plate 13 is not integrated into an integral lower tray 63 of the type shown in FIGS. 1 to 3. The top plate 13, rather, is concave towards the bottom plate 15. The main part 29 of the top plate 13 thus extends with an edge 95 projecting towards the bottom plate 15. The projecting edge 95 is extended by a projecting flange 97, which is pressed against the bottom plate 15. The projecting flange 97 is sealingly attached to the bottom plate 15.

The invention has been described with upper and lower fins formed by plates bent into slots. Alternatively, the lower fins are not formed by a plate bent into slots. They are formed by several bent plates, each plate defining one or more fins. The bent plate(s) need not be bent into slots, but may be bent to any other profile, provided that it allows the transmission of forces between the protective plate and the bottom plate. The situation is the same for the upper fins.

A second embodiment of the invention will now be described, with reference to FIGS. 6 and 7.

Only the points in which this variant differs from that of FIGS. 1 to 3 will be detailed below. Elements that are identical or perform the same function in both embodiments will be designated by the same references.

In the second embodiment, the battery 1 comprises:

an upper angle 101 extending around the entire periphery of the enclosure 5, comprising a first upper flange 103 pressed against the frame 28 and rigidly connected to the frame 28, and a second upper flange 105 extending opposite the upright edge 67;
a lower angle 107 extending around the entire periphery of the enclosure 5, comprising a first lower flange 109 pressed against the frame 28 and rigidly connected to the frame 28, and a second lower flange 111 extending opposite the upright edge 67;

Typically, the battery 1 does not comprise the external mechanical reinforcement 73.

The top angle 101 is L-shaped in cross-section, with the first and second upper flanges 103, 105 being substantially perpendicular to each other.

More specifically, the first upper flange 103 is substantially perpendicular to the normal direction N. The second upper flange 105 is substantially parallel to the normal direction N.

Similarly, the lower angle 107 is L-shaped in cross-section, with the first and second lower flanges 109, 111 being substantially perpendicular to each other.

More specifically, the first lower flange 109 is substantially perpendicular to the normal direction N. The second lower flange 111 is substantially parallel to the normal direction N.

The lower plate 15 has a substantially flat outer edge 113 (FIG. 7). It does not comprise an edge 45 protruding towards the top plate, nor a protruding flange.

The first upper flange 103 is pressed against an upper surface 115 of the bottom plate 15, facing the upper plate 13. It is pressed against the flat outer edge 113 of the bottom plate 15.

The bottom of the lower tray 63, i.e. the upper plate 13, has a central area 117 slightly concave towards the bottom plate 15, surrounded by a peripheral area 119 sealingly attached to the first upper flange 103.

Thus, the circulation volume 17 is sealed at its periphery by the upper angle 101.

The peripheral edge 75 of the protective plate 23 is substantially flat (FIG. 7), and extends in the same plane as the main area 33.

The first lower flange 109 is pressed against a lower surface 121 of the protective plate 23, facing away from the bottom plate 15. It is pressed against the flat peripheral edge 75 of the protective plate 23.

The second lower flange 111 and the second upper flange 105 are pressed against each other and are rigidly attached to each other. The second lower flange 111 is located outwards from the second upper flange 105.

The first upper flange 103 and the first lower flange 109 are superimposed at a distance one above the other in the normal direction N. They each have a width of more than 30 mm, preferably between 30 and 70 mm, typically 50 mm. In other words, the first upper flange 103 and the first lower flange 109 are superimposed along the normal direction N over a width L of at least 30 mm, preferably between 30 and 70 mm.

The upper and lower angles 101 and 107 are preferably made of a martensitic steel with an ultimate tensile strength (noted Rm in the text below) of between 900 MPa and 2,000 MPa. The lower fins are for example made of two-phase steel (ferrite and martensite) with an Rm of 1,000 MPa, or pure martensitic steel with an Rm of 1,200 to 1,700 MPa.

Typically, the top and bottom angles 101 and 107 are 2 mm thick. The bottom plate 15 and the protective plate 23 are each about 1 mm thick. The lower fins 27 have a height of between 4 mm and 20 mm, typically 14 mm.

The upper and lower angles 101 and 107 serve to reinforce the frame 28 all around. In particular, they are designed to give the battery 1 good resistance to side impacts.

Side impacts are when an object hits the vehicle from the side. Typically, a pole with a diameter of about 150 mm is considered to hit the vehicle at about 50 km/h. Depending on the case, a quasi-static force of 100 to 200 kN or an impact with an energy of 10 kJ can be considered.

In this case, the angles are particularly stressed.

The most rigid area of the structure is the area where the angles 101 and 107 are attached to the frame 28. It is therefore important that the angles are overlapped by a sufficient width L, e.g. about 50 mm. This rating depends on the stresses. In this area, there are two horizontal plates of 3 mm thickness, connected by 1 mm fins, across the width L.

The second lower flange 111 and the second upper flange 105 significantly stiffen the structure and also help to prevent tipping.

Beyond the width L, the whole structure consisting of the bottom plate 15, the protective plate 23, the upper fins 19 and the lower fins 27 helps to distribute the force in the rest of the frame.

Using the design described above, the penetration of a pole with a static load of 200 kN is only 4 mm.

Furthermore, the lower fins 27 form an angle of between 30° and 60° to the normal direction N. This angle is typically between 40° and 50°, and preferably 45°.

Such an inclination is particularly favourable in case of intrusion from below. This is because the battery frame 28 is exposed to impacts from rocks, branches, or any other body on the running surface.

These impacts are simulated by a so-called “drop weight” test, corresponding to a 200 J impact with a sphere or half-sphere of 180 mm diameter for example. After this impact, there must be no intrusion into the modules (a critical case that can lead to cell damage and the creation of a short circuit that could result in a battery fire).

In this case, the role of the lower fins 27 is particularly critical. If the lower fins 27 are vertical, they have maximum stiffness in the normal direction N. During the impact, they will tend to transfer the entire force generated by the sphere to the bottom plate 15. As a result, the crushing of the protective plate 23/lower fins 27/bottom plate 15 sandwich is reduced, and little or no energy is absorbed from the impact. The structure bends, without absorbing energy. In such a case, it is the upper fins 19 that must fully absorb the bending of the 23/27/15 sandwich. These fins are not designed for this purpose.

Providing that the lower fins 27 have an angle of between 30° and 60° to the normal direction N increases the structure's ability to absorb an impact from below. The fins 27 have a much lower vertical stiffness than with a 90° angle, without affecting side impact performance. At an impact of 200 J, the protective plate 23 is depressed by 5 mm, the bottom plate 15 is depressed by 2 mm, and the upper plate 7 is not deformed.

This effect is further enhanced when, advantageously, the upper fins 19 form an angle of between 30° and 60° to the normal direction N, preferably between 40° and 50°, and being for example 45°.

As described above, the upright edge 67 of the lower tray 63 comprises two substantially straight first sections 77, substantially parallel and opposite each other, and two substantially straight second sections 79, substantially parallel to each other and connecting the two first sections 77 to each other.

Typically, when the battery is installed in the vehicle, the first sections 77 are oriented along the transverse axis of the vehicle, and the second sections 79 are oriented along the longitudinal axis, i.e. along the direction of normal vehicle travel.

According to an advantageous aspect, the second direction D2 forms an angle between 30° and 60° with respect to the second upper flange 105, preferably between 40° and 50°, and being for example 45°.

This ensures that the lower fins 27 react in a laterally intrusive manner both along the longitudinal axis of the vehicle and along the transverse axis of the vehicle.

Typically, structures are designed to respond preferentially perpendicular to the vehicle's longitudinal axis. However, these structures perform poorly in the event of a longitudinal impact.

According to a variant illustrated in FIGS. 8 to 10, the frame 28 advantageously comprises an additional protective plate 121 covering the protective plate 23, and delimiting with the protective plate 23 an additional volume 123 (FIG. 8). It also has additional fins 125 housed in the additional volume 123.

The additional fins 125 extend in a third direction D3 and are arranged to transmit forces between the protective plate 23 and the additional protective plate 123.

The third direction D3 forms an angle with the second direction D2 of between 60° and 120°, preferably between 75° and 105°, for example 90°.

Typically, the additional protective plate 121 is made of the same material and has the same thickness as the protective plate 23.

The additional fins 125 are formed by a metal plate 127 bent into notches (FIG. 10). They are typically made of the same material and have the same thickness as the lower fins 27. They have the same geometry as the lower fins, and in particular form an angle of between 30° and 60° to the normal direction N, preferably between 40° and 50°, and for example 45°. They have approximately the same height, in the normal direction, as the lower fins 27.

The frame 28 described above with reference to FIGS. 7 and 8 is not torsionally symmetrical due to the orientation of the fins less than 45° to the second sections 79. However, this design is satisfactory in the case of a battery for a hybrid vehicle. The size of the battery is then typically 1 m by 70 cm and its mass is about 150 kg. In the case of a battery for an exclusively electrically propelled vehicle, the battery has a longitudinal length of approximately 3 m, a transverse width of 1.4 m and a mass of 600 kg. In addition, such a battery is part of the vehicle chassis and must therefore have high mechanical characteristics in bending and torsion.

These mechanical characteristics are achieved by the addition of the additional protective plate 123 and the additional fins 125, and by the orientation of the additional fins 125. The lower fins 27 are steeply inclined to the longitudinal and transverse axes of the vehicle. The additional fins 125 are also steeply inclined to the longitudinal and transverse axes of the vehicle, and are also almost perpendicular to the lower fins 27. This ensures that the frame 28 behaves in the same way in all directions, in terms of torsion, bending and impact.

In this embodiment, the upper angles 101 are attached to the protective plate 23 and the lower angles 107 are attached under the additional protective plate 121.

FIG. 7 shows a motor vehicle equipped with a battery according to the above-described embodiment.

The lower fins 27 are represented schematically by dashed lines. It appears that the third direction D3 forms an angle between 30° and 60° with the longitudinal direction L.

The second direction D2 also forms an angle between 30° and 60° with the longitudinal direction L, and forms an angle between 30° and 60° with the second direction D2.

Thus, the invention proposes a battery comprising:

a substantially flat frame 28, surrounded by angles 101, 107;

an enclosure 5 in which the electricity storage cells 3 are housed;

and a heat exchanger 11 between the two.

These different elements are mechanically linked to each other, which makes the assembly mechanically strong.

The frame 28 is flat above (bottom plate 15) and below (protective plate 23).

Existing batteries are generally flat-bottomed on the road side, but have side rails and crossbars on the cell side, at the level of the inside of the lower tray 65, which makes the inside floor of the battery non-flat and therefore incompatible with the construction of a heat exchanger. For this reason, this heat exchanger is very often housed inside the volume where the cells are located, with the risk of filling this volume with coolant in the event of a leak.

The bottom tray 63 and the lid 65 are deep-drawn and therefore completely sealed. Sealing is only required at the parting lines between the bottom tray 63 and the lid 65, and at the cable bushings.

In the usual structures, the frame is made of several welded parts, at great risk to leak-tightness.

The various structural elements of the battery, in particular the frame 28 and the heat exchanger 11, are preferably made of steel, adapting their strength to the stresses. The use of high-yield-strength steel allows a reduction in thickness for the same mechanical performance.

In this case, laser welding is preferred to have less deformation. Arc welding can be considered. Soft soldering (low temperature) can also be used to join certain parts where the soldered area is large and the stress concentrations are less than the mechanical capability of the soldered joint. Gluing can also be used, for example, to bond the upper fins 19 to the top and bottom plates 13, 15. Soldering is not recommended due to its high temperature which will destroy the mechanical characteristics of the steel (annealed)

Alternatively, the various structural elements of the battery are made of aluminium or aluminium alloys. In this case, the thicknesses of the structural parts must be adapted to obtain the same mechanical performance.

In this case, laser welding, gluing, soft or hard soldering, or even arc welding can be used.

In another variant, steel is used for the frame elements and the angles, and aluminium for the rest of the structure, which is less stressed.

In yet another variant, the lid is made of SMC or any other plastic with the required properties.

The protective plate 23 and the additional protective plate 123, as the case may be, are made of RTM.

It should be noted that the various technical aspects described in relation to the two embodiments can be combined with each other.

Thus, it is possible to arrange angles on the battery in the first embodiment, and it is possible to arrange an external metal reinforcement in the second embodiment.

The additional protective plate and the additional fins can be added to the first embodiment.

1. An electricity storage battery for a vehicle, the battery (1) comprising:
a plurality of electricity storage cells (3);
an enclosure (5) internally delimiting a volume (7) for receiving the electricity storage cells (3);
a heat exchanger (11) comprising an top metal plate (13) defining the bottom of the enclosure (5), a bottom plate (15) delimiting with the upper plate (13) a volume (17) for the circulation of a heat-transfer fluid, and a plurality of upper fins (19) housed in the circulation volume (17), the upper fins (19) extending in a first direction (D1), the upper fins (19) being arranged to transmit forces between the top and bottom plates (13, 15)
a protective plate (23) covering the bottom plate (15) and defining with the bottom plate (15) a lower volume (25);
lower stiffening fins (27) housed in the lower volume (25), the lower fins (27) extending in a second direction (D2) and being arranged to transmit forces between the protective plate (23) and the bottom plate (15), the bottom plate (15) forming, with the lower fins (27) and the protective plate (23), a rigid frame (28) taking up most of the forces to which the battery (1) is subjected.

2. A battery according to claim 1, wherein the enclosure (5) comprises a lower tray (63) and a lid (65), the lower tray (63) comprising the top plate (13) and an upright edge (67) tending towards the lid (65).

3. A battery according to claim 2, wherein the battery (1) comprises an external mechanical reinforcement (73), interposed between the upright edge (67) of the lower tray (63) and a peripheral edge (75) of the protective plate (23).

4. A battery according to claim 3, wherein the upright edge (67) comprises two first sections (77) parallel to the first direction (D1) and two second sections (79) parallel to the second direction (D2) and connecting the two first sections (77) to each other, the external mechanical reinforcement (73) comprising two third plates (81) bent into slots parallel to the first direction (D1) and applied against the first sections (77), and two fourth plates (83) bent into slots parallel to the second direction (D2) and applied against the second sections (79).

5. A battery according to claim 3 or 4, wherein the protective plate (23) comprises a central bottom (87), the peripheral edge (75) comprising two first segments (89) parallel to the first direction (D1) and integral with the central bottom (87) made of a first material, and two second segments (91) parallel to the second direction (D2) and made of a second material less rigid than the first material.

6. A battery according to any one of the preceding claims, wherein the first and second directions (D1, D2) form an angle between 60° and 120° with each other.

7. A battery according to any of the preceding claims in combination with claim 2, wherein the battery (1) comprises:
* an upper angle (101) extending around the entire periphery of the enclosure (5), comprising a first upper flange (103) pressed against the frame (28) and rigidly connected to the frame (28), and a second upper flange (105) extending opposite the upright edge (67);
* a lower angle (107) extending around the periphery of the enclosure (5), comprising a first lower flange (109) pressed against the frame (28) and rigidly connected to the frame (28), and a second lower flange (111) extending opposite the upright edge (67).

8. A battery according to claim 7, wherein the first upper flange (103) of the upper angle (101) and the first lower flange (109) of the lower angle (107) are superimposed at a distance apart, one above the other, and each have a width of more than 30 mm.

9. A battery according to claim 7 or 8, wherein the second upper flange (105) of the upper angle (101) and the second lower flange (111) of the lower bracket (107) are pressed against each other and are rigidly attached to each other.

10. A battery according to any one of the preceding claims, wherein the lower fins (27) form an angle of between 30° and 60° to a normal direction (N) substantially perpendicular to the first and second directions (D1, D2).

11. A battery according to any one of the preceding claims, wherein the frame (28) comprises an additional protective plate (121) covering the protective plate (23), and delimiting with the protective plate an additional volume (123), and additional fins (125) housed in the additional volume (123), the additional fins (125) extending along a third direction (D3) and being arranged to transmit forces between the protective plate (23) and the additional protective plate (121).

12. A battery according to claim 11, wherein the third direction (D3) forms an angle of between 60° and 120° with the second direction (D2).

13. A vehicle comprising an electricity storage battery (1) according to claim 11 or 12, the vehicle having a longitudinal direction (L) of normal travel, the third direction (D3) forming an angle of between 30° and 60° to the longitudinal direction (L).
